(19) United States
(12) Patent Application Publication
(10) Pub. No.: US 2026/0247288 A1
(43) Pub. Date: Aug. 20, 2026

(54) WIRELESS COMMUNICATION METHOD, TERMINAL DEVICE, AND NETWORK DEVICE

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/647,816

(22) Filed: Apr. 14, 2026

Related U.S. Application Data
(63) Continuation of application No. PCT/CN2024/132392, filed on Nov. 15, 2024.

(51) Int. Cl. H04W 52/02

(52) U.S. Cl. CPC H04W 52/0235; H04W 52/0212

(57) ABSTRACT

Provided are a wireless communication method, a terminal device, and a network device. An example method includes: receiving a first low-power wake-up signal (LP-WUS) from a network device; and in response to receiving the first LP-WUS, monitoring a physical downlink control channel (PDCCH) in a first time period.

### CROSS-REFERENCE TO RELATED APPLICATIONS

This application is a continuation of International Application No. PCT/CN2024/132392, filed on Nov. 25, 2024, the disclosure of which is hereby incorporated by reference in its entirety.

### TECHNICAL FIELD

The present application relates to the field of communications technologies, and more specifically, to a wireless communication method, a terminal device, and a network device.

### BACKGROUND

A low-power receiver and a low-power wake-up signal (low-power wake-up signal, LP-WUS) are introduced into a communications system. When a terminal device is idle, a main receiver may be disabled, or a main receiver may be set to a deep sleep state. An LP-WUS is monitored only by using the low-power receiver, thereby reducing power consumption of the terminal. However, how to embed the LP-WUS into the conventional communications system to further reduce the power consumption of the terminal device is an urgent problem to be resolved.

### SUMMARY

The present application provides a wireless communication method, a terminal device, and a network device. Various aspects involved in the present application are described below.

According to a first aspect, a wireless communication method is provided, including: receiving, by a terminal device, a first low-power wake-up signal LP-WUS transmitted by a network device; and in response to reception of the first LP-WUS, monitoring, by the terminal device, a physical downlink control channel (physical downlink control channel, PDCCH) in a first time period.

According to a second aspect, a wireless communication method is provided, including: transmitting, by a network device, a first low-power wake-up signal LP-WUS to a terminal device, where the first LP-WUS is used to trigger the terminal device to monitor a physical downlink control channel PDCCH in a first time period.

According to a third aspect, a terminal device is provided, including: a receiving unit, receiving a first low-power wake-up signal LP-WUS transmitted by a network device; and a monitoring unit, where in response to reception of the first LP-WUS, the monitoring unit is configured to monitor a physical downlink control channel PDCCH in a first time period.

According to a fourth aspect, a network device is provided, including: a transmitting unit, transmitting a first low-power wake-up signal LP-WUS to a terminal device, where the first LP-WUS is used to trigger the terminal device to monitor a physical downlink control channel PDCCH in a first time period.

According to a fifth aspect, a terminal device is provided, including a processor, a memory, and a communications interface. The memory is configured to store one or more computer programs, and the processor is configured to invoke the computer program in the memory, to cause the terminal device to perform a part or all of the steps of the method in the first aspect.

According to a sixth aspect, a network device is provided, including a processor, a memory, and a transceiver. The memory is configured to store one or more computer programs, and the processor is configured to invoke the computer program in the memory, to cause the network device to perform a part or all of the steps in the method in the second aspect.

According to a seventh aspect, an embodiment of the present application provides a communications system. The system includes the foregoing terminal device and/or the foregoing network device. In another possible design, the system may further include another device that interacts with the terminal device or the network device in the solutions provided in embodiments of the present application.

According to an eighth aspect, an embodiment of the present application provides a computer-readable storage medium. The computer-readable storage medium stores a computer program. The computer program causes a communications device (for example, a terminal device or a network device) to perform a part or all of the steps in the method in the foregoing aspects.

According to a ninth aspect, an embodiment of the present application provides a computer program product. The computer program product includes a non-transitory computer-readable storage medium that stores a computer program. The computer program is operable to cause a communications device (for example, a terminal device or a network device) to perform a part or all of the steps in the method in the foregoing aspects. In some implementations, the computer program product may be a software installation package.

According to a tenth aspect, an embodiment of the present application provides a chip. The chip includes a memory and a processor, and the processor may invoke a computer program from the memory and run the computer program, to implement a part or all of the steps in the method in the foregoing aspects.

In embodiments of the present application, the terminal device monitors the PDCCH in the first time period in response to the received LP-WUS (also referred to as a “first LP-WUS”). Intermittently activating monitoring of the PDCCH is configured by using connected discontinuous reception (connected discontinuous reception, C-DRX) in conventional solutions. In comparison, the present invention facilitates avoiding unnecessary PDCCH monitoring (for example, in an inactive time period), to reduce power consumption of the terminal device.

### BRIEF DESCRIPTION OF THE DRAWINGS

FIG. 1 shows a wireless communications system 100 to which an embodiment of the present application is applied.

FIG. 2 is a schematic flowchart of a wireless communication method according to an embodiment of the present application.

FIG. 3 shows an architecture of a second receiver to which an embodiment of the present application is applicable.

FIG. 4 shows an architecture of another second receiver to which an embodiment of the present application is applicable.

FIG. 5 shows an architecture of still another second receiver to which an embodiment of the present application is applicable.

FIG. 6 is an example diagram of a first time offset according to an embodiment of the present application.

FIG. 7 is an example diagram of another first time offset according to an embodiment of the present application.

FIG. 8 is an example diagram in which a terminal device transmits first acknowledgment information and second acknowledgment information.

FIG. 9 is a schematic diagram of a terminal device according to an embodiment of the present application.

FIG. 10 is a schematic diagram of a network device according to an embodiment of the present application.

FIG. 11 is a schematic diagram of a structure of a communications apparatus according to an embodiment of the present application.

### DETAILED DESCRIPTION OF THE EMBODIMENTS

The technical solutions in the present application are described below with reference to the accompanying drawings.

FIG. 1 shows a wireless communications system 100 to which an embodiment of the present application is applied. The wireless communications system 100 may include a network device 110 and terminal devices 120. The network device 110 may be a device that communicates with the terminal device 120. The network device 110 may provide communication coverage for a specific geographic area, and may communicate with the terminal device 120 located within the coverage.

FIG. 1 schematically shows one network device and two terminals. Optionally, the wireless communications system 100 may include a plurality of network devices, and another quantity of terminal devices may be included within coverage of each network device. This is not limited in embodiments of the present application.

Optionally, the wireless communications system 100 may further include other network entities such as a network controller and a mobility management entity. This is not limited in embodiments of the present application.

It should be understood that the technical solutions in embodiments of the present application may be applied to various communications systems, such as a code division multiple access (code division multiple access, CDMA) system, a time division multiple access (time division multiple access, TDMA) system, a frequency division multiple access (frequency division multiple access, FDMA) system, an orthogonal frequency division multiple access (orthogonal frequency division multiple access, OFDMA) system, a single-carrier frequency division multiple access (single-carrier frequency division multiple access, SC-FDMA) system, a 5th generation (5th generation, 5G) system or a new radio (new radio, NR) system, a long term evolution (long term evolution, LTE) system, an LTE frequency division duplex (frequency division duplex, FDD) system, and an LTE time division duplex (time division duplex, TDD) system. The terms “system” and “network” in embodiments of the present application are often used interchangeably. The described technologies may be used in the foregoing system and the foregoing radio technologies, or may be used in other systems and radio technologies. The following describes an NR system as an example. NR terms are used in most of the following description. However, these technologies may also be applied to applications other than NR system applications, such as a future communications system (for example, a 6^{th} generation (6^{th} generation, 6G) mobile communications system, such as a satellite communications system). The wireless communications system includes a terminal device and a network device.

The terminal device in embodiments of the present application may also be referred to as a user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (Pad), a laptop computer (laptop computer) or referred to as a notebook computer, a personal digital assistant (personal digital assistant, PDA), a palmtop computer, a netbook, an ultra-mobile personal computer (ultra-mobile personal computer, UMPC), a mobile Internet device (mobile internet device, MID), a wearable device (wearable device), a virtual reality (virtual reality, VR) device, an augmented reality (augmented reality, AR) device, a robot, a vehicle-mounted device (vehicle user equipment, VUE), a pedestrian user equipment (pedestrian user equipment, PUE), a smart home appliance (a home device having a wireless communication function, for example, a refrigerator, a television, a washing machine, or furniture), a game console, a personal computer (personal computer, PC), a teller machine or a self-service machine, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. The wearable device includes a smart watch, a smart band, a smart headset, smart glasses, smart jewelry (a smart wrist bangle, a smart wrist chain, a smart ring, a smart necklace, a smart ankle bangle, a smart ankle chain, and the like), a smart wristband, smart clothing, and the like. Optionally, the UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relay of a communication signal through a base station. It should be noted that a specific type of the terminal device is not limited in embodiments of the present application.

The network device in embodiments of the present application may be a device configured to communicate with the terminal device, and may include an access network device or a core network device. The access network device may also be referred to as a radio access network device, a radio access network device, a radio access network (radio access network, RAN), a radio access network function, or a radio access network unit. For example, the access network device may be a base station WLAN access point or a WiFi node. The access network device in embodiments of the present application may be a wireless access network node (or device) that connects the terminal device to a wireless network. The base station may broadly cover various names below, or may be interchanged with names below, for example, a NodeB (NodeB), an evolved NodeB (evolved NodeB, eNB), a next-generation NodeB (next generation NodeB, gNB), a relay station, an access point, a base transceiver station (base transceiver station, BTS), a radio base station, a radio transceiver, a basic service set (basic service set, BSS), an extended service set (extended service set, ESS), a home B node, a home evolved B node, a transmitting and receiving point (transmitting and receiving point, TRP), a transmitting point (transmitting point, TP), a master eNodeB MeNB, a secondary eNodeB SeNB, a multi-standard radio (MSR) node, a home base station, a network controller, an access node, a radio node, an access point (access point, AP), a transmitting node, a transceiver node, a baseband unit (baseband unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), a positioning node, or another appropriate term in the field, provided that same technical effect is achieved. The base station is not limited to a specific technical word. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communication, a network-side device in a 6G network, a device that functions as a base station in a future communications system, or the like. The base station may support networks of a same access technology or different access technologies. A specific technology and a specific device used by the network device are not limited in embodiments of the present application. It should be noted that in embodiments of the present application, a base station in an NR system is only used as an example for description, and a specific type of the base station is not limited.

The base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

In some deployments, the network device in embodiments of the present application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or a part of functions of the communications device in the present application may also be implemented by software functions running on hardware, or by virtualization functions instantiated on a platform (for example, a cloud platform).

In a cellular network, the terminal device (for example, a terminal device in a 5G network) usually consumes tens of milliwatts even if no data is transmitted or received. Power consumption of the terminal device in an idle state is caused because the terminal device must perform periodic measurement and check a potential paging message. Therefore, it is difficult to implement an Internet of things device in practice without support of an external power supply.

To resolve the foregoing problem, a low-power receiver and an LP-WUS are introduced into the communications system (for example, NR). When the terminal device is idle, a main receiver may be disabled, or a main receiver may be set to a deep sleep state. An LP-WUS is monitored only by using the low-power receiver, thereby reducing power consumption of the terminal. However, how to embed the LP-WUS into the conventional communications system to further reduce the power consumption of the terminal device is an urgent problem to be resolved.

For example, when the main receiver of the terminal device is woken up, the terminal device enters a radio resource control (radio resource control, RRC) connected state (CONNECTED), and the low-power receiver of the terminal device may be continuously enabled to receive the LP-WUS. Therefore, the low-power receiver is independent of the main receiver, that is, the main receiver can be disabled when the low-power receiver is in an active state and searches for a potential LP-WUS. Considering that a moment at which the terminal device monitors the LP-WUS may be in a reduced-power PDCCH monitoring (monitor) time period, the LP-WUS may be applied to C-DRX, to further reduce the power consumption of the terminal device. However, currently, there is no related solution. In addition, false wake-up may exist when a plurality of terminal devices simultaneously monitor the LP-WUS.

To resolve the foregoing problem, an embodiment of the present application provides a wireless communication method. The terminal device monitors a PDCCH in a first time period in response to the received LP-WUS (hereinafter referred to as a “first LP-WUS”). Intermittently activating monitoring of the PDCCH is configured by using C-DRX in conventional solutions. In comparison, the present invention facilitates avoiding unnecessary PDCCH monitoring (for example, in an inactive time period), to reduce power consumption of the terminal device.

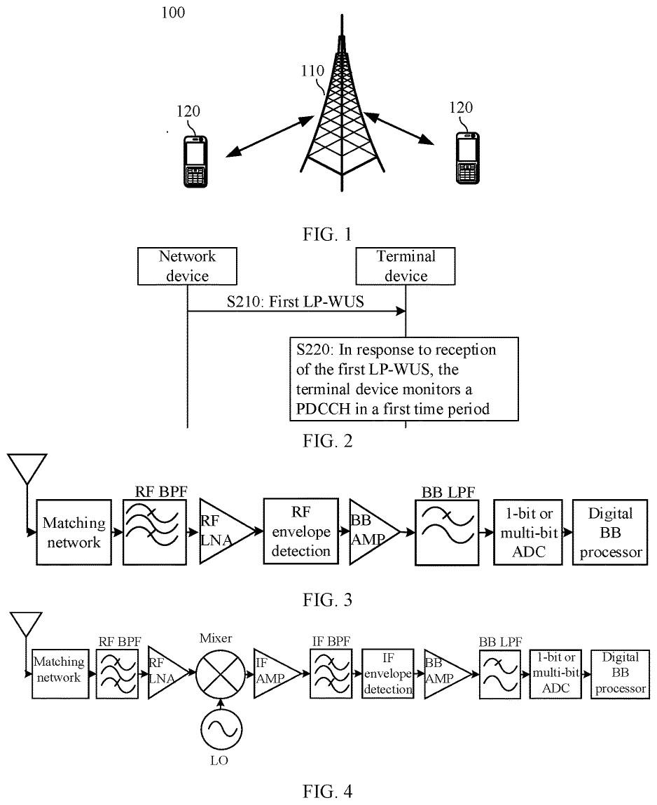

The following describes the wireless communication method according to this embodiment of the present application with reference to FIG. 2. FIG. 2 is a schematic flowchart of a wireless communication method according to an embodiment of the present application. The solution illustrated in FIG. 2 includes step S210 and step S220.

In step S210, a network device transmits a first LP-WUS to a terminal device. Correspondingly, the terminal device receives the first LP-WUS transmitted by the network device.

In some implementations, the terminal device includes a first receiver and a second receiver. Power consumption of the first receiver is higher than power consumption of the second receiver. The first LP-WUS is received by the second receiver of the terminal device. In other words, the first LP-WUS is detected by the terminal device through monitoring by using the second receiver.

In some implementations, the power consumption of the first receiver is higher than the power consumption of the second receiver. Therefore, the first receiver may be a main receiver (main receiver, MR), and the second receiver may be a low-power receiver (low-power receiver, LR).

In some implementations, the first receiver may also be referred to as a “main communications module”, and the second receiver may also be referred to as a low-power wake-up module or a low-power wake-up receiver (low power wake up receiver, LP-WUR).

If the first LP-WUS is embedded into a conventional communications system, generation of the first LP-WUS is required to be seamlessly integrated into signal generation in a conventional communications system. For ease of receiving the first LP-WUS, in some implementations, an architecture of the second receiver applicable to receiving the first LP-WUS includes one or more of the following: an architecture with radio frequency (radio frequency, RF) envelope detection; a heterodyne architecture with intermediate frequency envelope detection; or a homodyne or zero intermediate frequency architecture with baseband envelope detection.

In some implementations, the architecture of the second receiver may be an architecture with RF envelope detection. For example, with reference to FIG. 3, an RF signal is directly converted into a baseband signal by using an RF envelope detector. There is no local oscillator (local oscillator, LO) and no phase-locked loop (phase-locked loop, PLL). In this way, relatively low power consumption can be implemented. A 1-bit or multi-bit analog-to-digital converter (analog to digital converter, ADC) may be applied. Some components, such as a radio frequency low-noise amplifier (low noise amplifier, LNA) and/or a baseband (baseband) asymmetric multi-processing (asymmetric multi-processing, AMP), a high-Q matching network and/or a radio frequency band-pass filter (band pass filter, BPF) and/or a baseband low-pass filter (low-pass filter, LPF) may be optionally applied. A plurality of high-Q matching networks and/or RF BPFs or a plurality of off-chip components may be required to support a plurality of frequency bands and/or carriers. This may be used to suppress neighboring channel interference or interference from signals and/or other LP-WUSs in a conventional communications system on neighboring subcarriers, and may support frequency band and/or carrier tunning.

In some implementations, the architecture of the second receiver may be a heterodyne architecture with intermediate frequency envelope detection. For example, with reference to FIG. 4, an RF signal is downconverted into an intermediate frequency (intermediate frequency, IF) signal by using an RF mixer with an LO. The IF signal is converted into a baseband signal through IF envelope detection. According to a design, there may be one or more intermediate frequency levels. Lower power consumption may be implemented by lowering requirements for accuracy and stability of the LO. A 1-bit or multi-bit ADC may be applied. The high-Q matching networks and/or the RF BPFs and/or the IF BPFs (and/or BB LPFs) may be used to suppress the neighboring channel interference or the interference from the other signals and/or the other LP-WUSs in the conventional communications system on the neighboring subcarriers. Some components may be optionally applied, such as an RF LNA and/or an IF AMP and/or a BB AMP. Frequency band and/or carrier tuning may be implemented by tuning an LO frequency. Sensitivity may be improved by applying the RF LNA and/or the IF AMP.

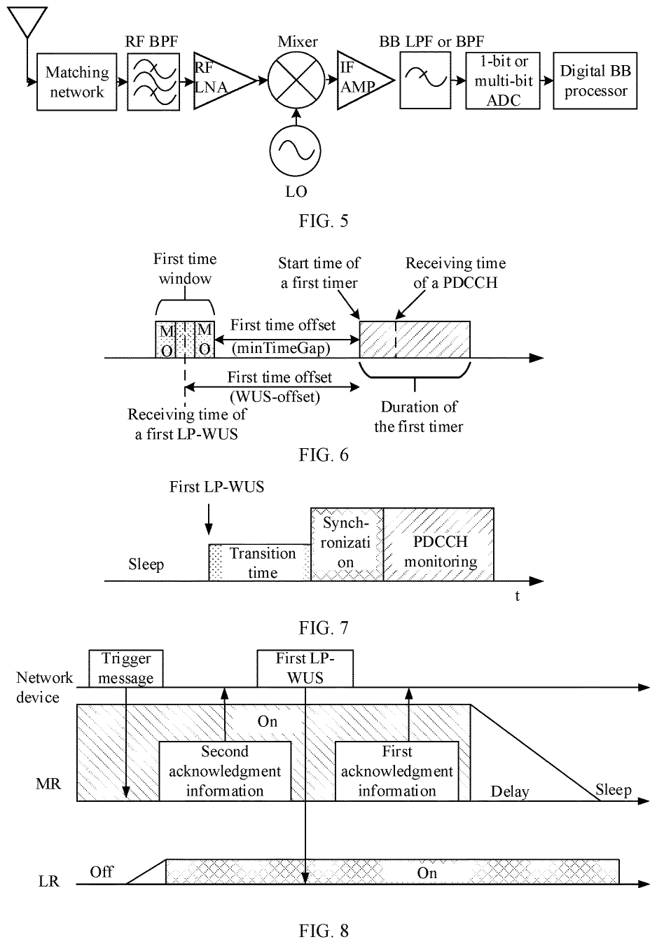

In some implementations, the architecture of the second receiver may be a homodyne or zero intermediate frequency architecture with baseband envelope detection. For example, with reference to FIG. 5, frequency band and/or carrier tuning may be implemented by tuning an LO frequency. It is more efficient and simpler to use the BB BPF/LPF rather than the high-Q matching network and/or the RF BPF to suppress the neighboring channel interference or the interference from the other signals and/or the other LP-WUSs in the conventional communications system on the neighboring subcarriers. The RF LNA may be applied to improve sensitivity. Baseband envelope detection may be performed in an analog domain (before the ADC) or a digital domain (after the ADC).

It should be noted that the foregoing three architectures of the second receiver may be applied to binary on-off keying (on-off keying, OOK) modulation. Certainly, some of these architectures may also be applied to other modulation, such as frequency shift keying (frequency shift keying, FSK).

In some implementations, in a multi-carrier on-off keying (multi-carrier on-off keying, MC-OOK) system based on orthogonal frequency division multiplexing (orthogonal frequency division multiplexing, OFDM), the network device may perform a multi-carrier amplitude shift keying (multi-carrier amplitude shift keying, MC-ASK) waveform by using encoded bits to generate the first LP-WUS.

In some implementations, the first LP-WUS may support a bandwidth of 5 MHz to 20 MHz. Therefore, when the first LP-WUS is embedded into a conventional communications system, there may be two receiving modules, or one receiving module may be obtained through integration. To be specific, the first receiver and the second receiver are two separate modules, or the first receiver and the second receiver are integrated into one module.

In step 220, in response to reception of the first LP-WUS, the terminal device monitors a PDCCH in a first time period.

In some implementations, in response to reception of the first LP-WUS, that the terminal device monitors the PDCCH in the first time period may be understood as that the terminal device is triggered, based on the first LP-WUS, to monitor the PDCCH in the first time period. In other words, the first LP-WUS is used to trigger the terminal device to monitor the PDCCH in the first time period. The first LP-WUS may be used to wake up the terminal device in an idle state (IDLE)/an inactive (INACTIVE) state, and may wake up the terminal device in a connected state to monitor the PDCCH. Performance of the first LP-WUS is much lower than that of a common PDCCH. A quantity of bits is also very limited. In consideration of this, power is saved for the terminal device.

In some implementations, the first LP-WUS triggers PDCCH monitoring in the connected state. For example, for the terminal device in the connected state, an LP-WUS may be configured through C-DRX. To be specific, the terminal device receives the first LP-WUS, and may be triggered, in the first time period, to perform PDCCH monitoring configured through C-DRX.

In some implementations, if the terminal device detects the PDCCH through monitoring in the first time period, the terminal device may continue to monitor data scheduled by using the PDCCH. To be specific, the terminal device continues to monitor data transmitted by using a transmission resource indicated by downlink control information (downlink control information, DCI) carried by the PDDCH.

In some implementations, the PDCCH is monitored by the first receiver. For example, the second receiver of the terminal device receives the first LP-WUS, and wakes up the first receiver in a sleep state, so that the first receiver enters a PDCCH monitoring state in the first time period.

In some implementations, that the terminal device monitors the PDCCH in the first time period may be understood as that the terminal device detects the PDCCH through monitoring in the first time period. If the terminal device detects the PDCCH through monitoring, the terminal device continues to monitor, based on the transmission resource indicated by the DCI carried by the PDCCH, the data transmitted on the transmission resource.

In some implementations, the first LP-WUS triggers the terminal device to monitor the PDCCH in the first time period. In other words, the first time period is a duration of PDCCH monitoring triggered by the first LP-WUS.

A key point of triggering PDCCH monitoring by the first LP-WUS is how to configure the duration of PDCCH monitoring triggered only by the first LP-WUS. In some implementations, the first time period is determined based on a first timer.

In some implementations, that the first time period is determined based on the first timer may be understood as that the first time period is determined based on a duration of the first timer. For example, the first time period may be determined based on a start time of the first timer. A start time of the first time period is the start time of the first timer, and an end time of the first time period is a time in the duration of the first timer or a time after an end time of the first timer.

In some implementations, the first time period is determined based on the first timer. It may be understood that the first time period is the duration of the first timer. In other words, the start time of the first time period is the start time of the first timer, and the end time of the first time period is the end time of the first timer. In this case, that the terminal device is triggered, based on the first LP-WUS, to monitor the PDCCH in the first time period may be understood as that the first LP-WUS triggers starting of the first timer, and the terminal device monitors the PDCCH during running of the first timer.

In some implementations, the first timer includes an existing timer and/or a newly defined timer.

In some implementations, the existing timer may be an existing discontinuous reception (discontinuous reception, DRX) inactivity timer (drx-InactivityTimer) configured through existing C-DRX. For example, the first timer is drx-InactivityTimer, and the terminal device receives the first LP-WUS to trigger starting of drx-InactivityTimer.

In some implementations, the existing timer may be an existing DRX on duration timer (drx-onDurationTimer) configured through C-DRX. For example, the first timer is drx-onDurationTimer, and the terminal device receives the first LP-WUS to trigger starting of drx-onDuration Timer.

In some implementations, the newly defined timer may be understood as a timer triggered by the first LP-WUS, that is, a dedicated timer of the LP-WUS or a newly designed timer of the LP-WUS.

In some implementations, a duration of the dedicated timer of the LP-WUS may be less than or equal to that of drx-onDurationTimer.

To determine a specific timer that can be triggered by the first LP-WUS or different timers triggered in different scenarios, in different scenarios, the terminal device should determine, according to a specific condition, a specific timer triggered by the first LP-WUS. In some implementations, the first timer is determined based on one or more of the following: a service type; a data transmission mode; a data traffic feature; a quality of service requirement; or network load information.

In some implementations, the service type may be understood as a service type of data scheduled by using the PDCCH. For example, the service type of the data scheduled by using the PDCCH may be voice or a video.

In some implementations, the data transmission mode may be understood as a transmission rule of the data scheduled by using the PDCCH. For example, the transmission mode of the data scheduled by using the PDCCH may be periodic or aperiodic, and predictable or unpredictable.

In some implementations, the data traffic feature may be understood as a traffic feature of the data scheduled by using the PDCCH in a data transmission process, for example, a traffic rate of the data scheduled by using the PDCCH in the data transmission process, and whether the traffic is continuous.

In some implementations, the quality of service requirement may be understood as a quality of service (Quality of Service, QoS) indicator of the data scheduled by using the PDCCH, for example, a data bandwidth, a delay, a packet loss rate, or jittering.

In some implementations, the network load information may be understood as a load condition of a current network.

In some implementations, the first timer is determined based on the data transmission mode. For example, for periodically transmitted data, a time of arrival of traffic is predictable, and the first timer may be drx-onDuration Timer. This is because it can be ensured that data can be received in time and power consumption can be saved by keeping a monitoring state in a short time before each transmission. For another example, for aperiodically transmitted data, the first timer may be drx-InactivityTimer, to ensure that the terminal device is kept in the monitoring state in a long time after data transmission starts. This is applicable to an application when the data transmission mode is not determined.

In some implementations, the first timer is determined based on the quality of service requirement. For example, when data of the application is sensitive to a delay and has a high requirement for quality of service (such as a video call or an online game), the first timer may be drx-onDurationTimer, to ensure that the terminal device can quickly respond to downlink data and keep a low delay. For another example, for a scenario with a low quality of service requirement (for example, periodic data synchronization and an Internet of things (internet of things, IOT) application), the first timer may be the dedicated timer of the LP-WUS, to ensure that the terminal device remains temporarily active when necessary and is in a low-power state in another time as much as possible.

In some implementations, the first timer is determined based on the network load information. For example, in a high-load network, the terminal device may need more time to process data transmission. Therefore, the first timer may be drx-InactivityTimer, so that the terminal device remains active in a transmission process, to avoid frequently waking up and sleeping in a case of a high load. For another example, when a network load is low, the first timer may be drx-onDurationTimer or the dedicated timer of the LP-WUS, so that the terminal device is woken up only when necessary and keeps running at low power consumption.

In some implementations, the first timer is determined based on the data transmission mode, the data traffic feature, and quality of service. For example, when the terminal device detects, based on the first LP-WUS, possibility that downlink data at a relatively high rate arrives, or real-time communication such as voice over Internet protocol (voice over internet protocol, VoIP) is sensitive to a delay and has periodic data transmission, the first timer may be drx-onDurationTimer, and drx-onDurationTimer may be started to ensure that the terminal device keeps an active state in a short time for ease of receiving data in time. Because drx-onDurationTimer is responsible for controlling the terminal device to keep the PDCCH monitoring state in each DRX cycle, when the timer is started, the terminal device continuously monitors the PDCCH to receive potential data transmission. For another example, after the first LP-WUS wakes up the terminal device, or continuous downlink data transmission (such as file downloading or video streaming) is expected, the first timer is drx-InactivityTimer. In this case, drx-InactivityTimer is started to facilitate keeping the terminal device active to continuously receive data. When the terminal device is in an active state, drx-InactivityTimer may be started and enter a DRX mode when no data transmission occurs. If data transmission ends and the timer does not expire, the terminal device remains in the active state and continues to monitor the PDCCH. If the timer expires and there is no new data, the terminal device enters the low-power state.

In some implementations, a start time of the first timer is determined based on a first time window and a first time offset, and the first time window is used to monitor the first LP-WUS.

In some implementations, the first time offset is used to indicate a time interval between a start time of the first time window and a start time of the first timer. Correspondingly, the start time of the first timer may be determined based on the start time of the first time window and the first time offset.

In some implementations, the first time offset is used to indicate a time interval between an end time of the first time window and a start time of the first timer. For example, with reference to FIG. 6, the first time offset is minTimeGap, and the start time of the first timer may be determined based on the end time of the first time window and minTimeGap.

In some implementations, the first time offset is used to indicate a time interval between a receiving time of the first LP-WUS in the first time window and a start time of the first timer. For example, with reference to FIG. 6, the first time offset is WUS-offset, and the start time of the first timer may be determined based on the receiving time of the first LP-WUS and WUS-offset.

In some implementations, the first time offset is configured by the network device, and the first time offset is determined based on one or more of the following: one or more candidate values of the first time offset reported by the terminal device; one or more candidate values of the first time offset supported by a subcarrier spacing (sub-carrier space, SCS); location information of the terminal device; a resource scheduling congestion degree; a data transmission cycle; a wake-up delay of the terminal device; a processing delay of the terminal device; or a monitoring cycle of the first LP-WUS.

In some implementations, the one or more candidate values of the first time offset reported by the terminal device may be understood as a part or all of the one or more first time offsets that are supported by the terminal device and reported by the terminal device to the network device.

In some implementations, the subcarrier spacing may be understood as frequency spacing between a plurality of subcarriers. For example, the subcarrier spacing may be one or more of the following: 15 kHz, 30 kHz, 60 kHz, 120 kHz, or 240 kHz.

In some implementations, the one or more candidate values of the first time offset supported by the SCS may be understood as one or more predefined or preconfigured first time offsets supported by the SCS. For example, as defined in a protocol, the SCS is 15 kHz, and three first time offsets are supported.

In some implementations, the one or more candidate values of the first time offset supported by the SCS may be understood as one or more first time offsets that are supported by the SCS and reported by the terminal device. For example, the terminal device determines, based on the SCS and a sleep state of the terminal device, one or more first time offsets supported by a value of each SCS.

In some implementations, the location information of the terminal device may be understood as an absolute location or a relative location of the terminal device to calculate a data transmission delay.

In some implementations, the resource scheduling congestion degree may be understood as a congestion degree of a transmission resource that is scheduled by the network device and used to transmit data.

In some implementations, the wake-up delay of the terminal device may be understood as indicating a transition time of the first receiver of the terminal device from the sleep state to the PDCCH monitoring state.

In some implementations, the processing delay of the terminal device may be understood as a protocol interaction time required from detecting the first LP-WUS to triggering starting of the first timer by the terminal device.

In some implementations, the monitoring cycle of the first LP-WUS may be understood as a cycle of monitoring the first LP-WUS by the terminal device, that is, a cycle of the first time window.

In some implementations, if the first time offset is used to indicate a time interval between the start time of the first time window and the start time of the first timer, the first time offset may be determined based on the data transmission cycle, the wake-up delay of the terminal device, and the monitoring cycle of the first LP-WUS. For example, if the data scheduled by using the PDCCH is VoIP, the data transmission cycle is T_{VoIP}, the wake-up delay of the terminal device is Δtₒₙ, and the monitoring cycle of the first LP-WUS is T_{LP-WUS}, the first time offset may be determined by using a formula Δt₁=T_{VoIP}−Δtₒₙ−T_{LP-WUS}.

In some implementations, if the first time offset is used to indicate the time interval between the start time of the first time window and the start time of the first timer, the start time of the first time window may be determined based on the start time of the first timer and the first time offset. In this case, the first time offset may be referred to as a monitoring advance time of the first LP-WUS. In other words, monitoring of the first LP-WUS starts from the first time offset before the start time of the first timer. It can be ensured by using the monitoring advance time of the first LP-WUS that the terminal device has enough time to complete monitoring of the first LP-WUS and wake-up of the terminal device before data arrives.

In some implementations, if the first time offset is used to indicate the time interval between the end time of the first time window and the start time of the first timer, the first time offset may be determined based on the one or more candidate values of the first time offset reported by the terminal device, the one or more candidate values of the first time offset supported by the SCS, the location information of the terminal device, and the resource scheduling congestion degree. For example, based on the resource scheduling congestion degree and the location information of the terminal device, the network device selects an appropriate first time offset for the terminal device from a plurality of candidate values of the first time offset, to adapt to different scenarios.

In some implementations, the one or more candidate values of the first time offset are determined based on one or more of the following: a time of processing the first LP-WUS by the terminal device; a transition time of switching from a second receiver of the terminal device to a first receiver of the terminal device; a synchronization duration of the first receiver; an SCS; a sleep type supported by the terminal device; a data transmission delay requirement; or network status information.

In some implementations, the time of processing the first LP-WUS by the terminal device may be understood as a time of receiving and decoding the first LP-WUS by the terminal device.

In some implementations, the transition time of switching from the second receiver of the terminal device to the first receiver of the terminal device may be understood as a time of switching from the second receiver in an on state to the first receiver in a sleep state and waking up the first receiver in the sleep state by the terminal device. For example, with reference to FIG. 7, after the second receiver of the terminal device receives the first LP-WUS, a time of switching from the second receiver to the first receiver in the sleep state and waking up the first receiver in the sleep state by the terminal device is the transition time.

In some implementations, the synchronization duration of the first receiver may be understood as an execution time or a frequency synchronization duration of the first receiver. For example, with reference to FIG. 7, after receiving the first LP-WUS, the second receiver of the terminal device triggers wake-up of the first receiver after a time of receiving and processing the first LP-WUS. After the first receiver is woken up from the sleep state, before PDCCH monitoring is performed, the first receiver is required to perform time or frequency synchronization, to facilitate PDCCH monitoring.

In some implementations, the data transmission delay requirement may be understood as a transmission delay requirement of the data scheduled by using the PDCCH. For example, the data transmission delay requirement may be a packet delay budget (packet delay budget, PDB).

In some implementations, the network status information may be understood as an indicator that can indicate a network status. For example, the network status information may be signal strength, a network load, or the like.

In some implementations, the sleep type supported by the terminal device may be understood as a sleep type supported by the first receiver of the terminal device. For example, the sleep type supported by the first receiver of the terminal device includes deep sleep and/or shallow sleep.

In some implementations, the candidate value of the first time offset is determined based on the time of processing the first LP-WUS by the terminal device. For example, different terminal devices may have different capabilities of processing the first LP-WUS. A stronger processing capability indicates that the terminal device can more quickly complete detection and decoding of the first LP-WUS, thereby shortening the first time offset. Therefore, the terminal device may select an appropriate candidate value based on a processing capability of the terminal device.

In some implementations, the candidate value of the first time offset is determined based on the network status information. For example, under an actual network condition, factors such as signal strength and a network load also affect selection of the first time offset. A strength level of a signal received by the first receiver may be used to select a candidate value of the first time offset. Each strength level corresponds to one candidate value of the first time offset. For another example, under a weak signal condition, the first receiver of the terminal device may need more time to perform synchronization, and therefore, a candidate value of the first time offset may be relatively large.

In some implementations, the candidate value of the first time offset is determined based on the SCS. For example, the SCS determines a bandwidth and a time domain feature of a signal. Therefore, when the SCS is relatively large (for example, 60 kHz or 120 kHz), a time synchronization requirement is higher, a response time of the terminal device may be required to be shortened, and the first time offset is also smaller. When the SCS is relatively small (for example, 15 kHz or 30 kHz), a synchronization process of the first receiver may take more time, and the first time offset is larger. Therefore, the terminal device is required to report an appropriate candidate value for each SCS.

In some implementations, one candidate value of the first time offset may be determined based on one SCS.

In some implementations, a plurality of candidate values of the first time offset may be determined based on one SCS. For example, because different factors (for example, an SCS, a sleep state, and a network condition) have different requirements for the first time offset, the plurality of candidate values of the first time offset may be determined based on each SCS.

In some implementations, the candidate value of the first time offset is determined based on the SCS and the sleep type supported by the terminal device. For example, each SCS corresponds to a plurality of candidate values, which are associated with different sleep types of the terminal device. The sleep type of the terminal device determines a wake-up time. In deep sleep, the terminal device fully disables most circuit modules, and therefore requires a relatively long time to restart processing. In shallow sleep, some modules remain active and can be relatively quickly woken up. This means that in different sleep types, the terminal device may select different first time offsets to balance power consumption and communication efficiency.

In some implementations, the candidate value of the first time offset is determined based on the data transmission delay requirement and the sleep type supported by the terminal device. For example, it is assumed that the terminal device supports two sleep types: micro sleep with a transition time of 0 ms and deep sleep with a transition time of 20 ms. When a PDB of the data scheduled by using the PDCCH is greater than 20 ms, the terminal device may report a candidate value of the first time offset greater than 20 ms. Alternatively, when a PDB of traffic is less than 20 ms, the terminal device reports a candidate value of the first time offset less than 20 ms. The network device more flexibly configures the first time offset for the terminal device based on different types of transmitted services.

In some implementations, the candidate value of the first time offset is determined based on the SCS, the sleep type supported by the terminal device, and the time of processing the first LP-WUS by the terminal device. For example, the candidate value of the first time offset may be determined by using a formula Δt₁=Δt_{sync}(SCS)+Δtₛₗₑₑₚ(type)+Δt_{wus}(process), where Δt_{sync}(SCS) is a time that is required for time synchronization and determined by the SCS, where the larger SCS indicates the smaller value, and the smaller SCS indicates the larger value; Δtₛₗₑₑₚ(type) is the wake-up time that is determined by the sleep type supported by the terminal device, where the value is small in shallow sleep, and the value is large in deep sleep; and Δ_{twus}(process) is the time of processing the first LP-WUS by the terminal device, where the stronger capability of the terminal device indicates the smaller value, and the weaker capability indicates the larger value. For another example, the SCS may be 15 kHz and 60 kHz, the sleep type supported by the terminal device may be shallow sleep and deep sleep, the time of processing the first LP-WUS by the terminal device may be fast processing and slow processing, and the candidate value of the first time offset may be determined based on a combination of the SCS, the sleep type supported by the terminal device, and the time of processing the first LP-WUS by the terminal device in Table 1.

TABLE 1

| SCS | | Time of processing | Candidate value of the |
|---|---|---|---|
| (kHz) | Sleep type | the first LP-WUS | first time offset (ms) |
| 15 | Shallow | Fast processing | 6 |
| | sleep | | |
| 15 | Shallow | Slow processing | 8 |
| | sleep | | |
| 15 | Deep sleep | Fast processing | 12 |
| 15 | Deep sleep | Slow processing | 15 |
| 60 | Shallow | Fast processing | 3 |
| | sleep | | |
| 60 | Shallow | Slow processing | 5 |
| | sleep | | |
| 60 | Deep sleep | Fast processing | 7 |
| 60 | Deep sleep | Slow processing | 9 |

In some implementations, the one or more candidate values of the first time offset reported by the terminal device may be reported by the terminal device to the network device by using a capability report.

In some implementations, the network device may configure the first time offset for the terminal device by using DCI. For example, the network device may configure the first time offset for the terminal device by using a DCI format 2_6 or another DCI format.

In some implementations, a duration of the first timer is determined based on a data transmission duration.

In some implementations, the data transmission duration may be understood as a total transmission duration of the data scheduled by using the PDCCH.

In some implementations, the duration of the first timer is determined based on the data transmission duration. It may be understood that the duration of the first timer is determined based on the data transmission duration and a second time offset.

In some implementations, the second time offset may be understood as a redundancy time that is used to ensure that the terminal device does not fall asleep prematurely, and may be usually set as a network propagation delay or a compensation time of a data transmission fluctuation.

In order that the terminal device can receive all the data scheduled by using the PDCCH, in some implementations, the duration of the first timer is determined by using a formula D_{timer 1}=t_{data}+∂, where t_{data} is the data transmission duration, and ∂ is the second time offset.

In some implementations, a cycle of the first timer is determined based on a data transmission cycle.

In some implementations, the data transmission cycle may be understood as a transmission cycle of the data scheduled by using the PDCCH.

To ensure efficient collaboration of the first timer in each DRX cycle, the cycle of the first timer, that is, the DRX cycle, should match a trigger moment of the first LP-WUS. In some implementations, the cycle of the first timer is greater than the data transmission cycle, to ensure that in some cases, the terminal device still has an opportunity to remonitor the PDCCH in a next DRX cycle when the first LP-WUS fails to be detected.

In some implementations, the cycle of the first timer is determined based on the data transmission cycle. It may be understood that the cycle of the first timer is determined based on the data transmission cycle and a third time offset.

In some implementations, the third time offset may be understood as small time compensation used to avoid a case in which a device misses PDCCH monitoring due to monitoring of a first LP-WUS or a random fluctuation of data transmission. Generally, a recommended value of the third time offset ranges from 1 millisecond to 2 milliseconds.

In some implementations, the cycle of the first timer is determined by using a formula T_{timer 1}=T_{data}+δ, where T_{data} is the data transmission cycle, and δ is the third time offset.

In some implementations, the cycle of the first timer is an integer multiple of the monitoring cycle of the first LP-WUS.

In some implementations, the monitoring cycle of the first LP-WUS may be understood as the cycle of monitoring the first LP-WUS by the terminal device, that is, the cycle of the first time window. Therefore, it can also be said that the cycle of the first timer is an integer multiple of the cycle of the first time window.

In some implementations, the first time window includes a plurality of monitoring occasions of the first LP-WUS, to improve the flexibility for the network device scheduling and LP-WUS transmission. For example, with reference to FIG. 6, the first time window includes a plurality of monitoring occasions (monitoring occasion, MO), and the MO is the monitoring occasion of the first LP-WUS. If the terminal device detects the first LP-WUS in the plurality of MOs, the terminal device determines the start time of the first timer based on the first time window and the first time offset.

In some implementations, the plurality of monitoring occasions of the first LP-WUS may be inconsecutive. This facilitates better processing of a case in which a monitoring resource of the first LP-WUS is used for another channel/signal or another purpose (for example, a conflict with a UL slot). Certainly, in this embodiment of the present application, the plurality of monitoring occasions of the first LP-WUS may alternatively be consecutive.

In some implementations, the monitoring occasion of the first LP-WUS may be determined based on one or more of the following: a system frame number; a subframe number; a monitoring cycle of the first LP-WUS; or a monitoring start offset of the first LP-WUS.

In a conventional standard protocol, a non-integer C-DRX cycle is defined to match a non-integer service cycle (for example, an extended reality (extended reality, XR) cycle). In consideration of low power consumption, a monitoring cycle, with a small granularity (for example, a value of 1 ms), of the first LP-WUS may be used to match the non-integer C-DRX cycle, and a non-integer monitoring cycle of the first LP-WUS is not defined. Because conventional drx-startOffset is defined for determining a start occasion of PDCCH monitoring, a monitoring start offset of the first LP-WUS (drx-WusStartOffset) may be used to determine the monitoring occasion of the LP-WUS.

In some implementations, the monitoring occasion of the first LP-WUS may be determined by using a formula [(SFN×10)+subframe number−(drx-WusStartOffset−timeOffset)] mod (LP-WUS-cycle), where SFN is the system frame number, subframe number is the subframe number, LP-WUS-cycle is the monitoring cycle of the first LP-WUS, drx-WusStartOffset is a monitoring start offset of the first LP-WUS, and timeOffset is an offset used to adjust the monitoring occasion of the first LP-WUS. In other words, a system frame and a subframe that meet a condition [(SFN×10)+subframe number−(drx-WusStartOffset−timeOffset)] mod (LP-WUS-cycle) may be used as the monitoring occasion of the first LP-WUS.

In some implementations, the start time of the first time window is determined based on one or more of the following: a data transmission start time; or the monitoring cycle of the first LP-WUS.

In some implementations, the data transmission start time may be understood as a transmission start time of the data scheduled by using the PDCCH.

In some implementations, the start time of the first time window is determined based on a data transmission start time and the monitoring cycle of the first LP-WUS.

The first timer may be responsible for controlling when the terminal device enters the PDCCH monitoring state. To start the timer before a data frame arrives at the terminal device, the start time of the first time window should be slightly earlier than a transmission cycle of the data frame. In some implementations, the start time of the first time window is determined by using a formula t_{time window 1}=t_{data}−T_{wus}, where t_{data} is the data transmission start time, and T_{wus} is the monitoring cycle of the first LP-WUS. For example, periodic traffic such as VoIP usually has a stable transmission cycle (for example, transmitting a voice frame every 20 ms). First, it is necessary to know a data transmission cycle T_{VoIP} and determine when data arrives in each cycle. Typically, a VoIP transmission cycle ranges from 20 ms to 50 ms. For applications such as VoIP, data transmission timing is predictable because a transmission rate of a voice frame is usually fixed. Therefore, based on these features, the network device may preconfigure an appropriate monitoring occasion of the first LP-WUS, that is, the start time of the first time window. To reasonably start the first timer before VoIP data arrives, the terminal device needs to monitor the first LP-WUS at a reasonable advance time point. The advance time point should be early enough, to ensure that there is enough time to wake up the device and the device prepares to receive data. However, the advance time point should not be excessively early to avoid a waste of power. It is assumed that a transmission cycle of VoIP traffic is T_{VoIP}, and a transmission start time is t₀. To wake up the device before data arrives and start the first timer, a monitoring start time of the first LP-WUS, that is, the start time of the first time window should be determined by using a formula t_{time window 1}=t₀−T_{wus}.

To efficiently use an LP-WUS, the network device and the terminal device need to cooperatively configure the DRX and LP-WUS mechanisms, so that a monitoring cycle of the LP-WUS matches the data transmission cycle. The terminal device can be woken up in advance before each data traffic cycle, and is kept in a low-power state when not required. In some implementations, the monitoring cycle of the first LP-WUS should be the same as the data transmission cycle. In other words, the cycle of the first time window is the same as the data transmission cycle.

In some implementations, a parameter of the first time window and/or the first timer is determined based on a network load and/or traffic information by using a model. For example, by using a model, a historical data transmission mode and a network load are analyzed, and a future traffic and load condition is predicted. Parameters such as the cycle of the first timer, the first time offset, and the cycle of the first timer are dynamically adjusted based on a prediction result of the model, to achieve more accurate energy saving effect. For another example, the monitoring cycle of the first LP-WUS may be dynamically adjusted. If the model predicts that traffic decreases or a network load decreases, the monitoring cycle of the first LP-WUS may be extended to reduce a wake-up frequency. The monitoring cycle of the first LP-WUS may be determined by using a formula T_{wus}=max{T_{data}−Δtₒₙ, Δt₁}, where T_{data} is the data transmission cycle, Δtₒₙ is the wake-up delay of the terminal device, and Δt₁ is the first time offset.

In some implementations, during running of the first timer, content reported by the terminal device may be determined based on a type of the timer.

In some implementations, if the first timer is drx-onDurationTimer or drx-InactivityTimer, the terminal device may report periodic channel state information (channel state information, CSI)/layer-1 reference signal received power (layer-1 reference signal received power, L1-RSRP). For example, if the first LP-WUS triggers drx-onDuration Timer, the periodic CSI/L1-RSRP should be reported in a dynamic PDCCH monitoring state.

Uplink (up-link, UL)/downlink (down link, DL) transmission may require CSI reporting, but L1-RSRP reporting is unnecessary. In some implementations, if the first timer is drx-onDuration Timer, the terminal device may choose not to report L1-RSRP.

In some implementations, if the first timer is a dedicated timer of the LP-WUS, whether the terminal device periodically reports the CSI/L1-RSRP during running of the dedicated timer of the LP-WUS may be configured as required.

To enable the terminal device to adapt to different data traffic types, in some implementations, the terminal device may monitor the first LP-WUS out of a conventional C-DRX active time and in an active time. For example, the first timer is drx-onDuration Timer. Monitoring of the first LP-WUS before drx-onDurationTimer may be applied to predictable periodic traffic such as VoIP. Monitoring of the first LP-WUS out of the conventional C-DRX active time is specifically designed for an unpredictable periodic service or a misaligned periodic service such as XR. For details, reference may be made to Table 2.

TABLE 2

| Feature | VoIP-type traffic | XR type traffic |
|---|---|---|
| Characteristic | Predictable and periodic | Unpredictable or aperiodic, |
| | | but inconsistent with a |
| | | conditional DRX cycle |
| Usage of an | Minimum, because a | Frequent, meeting a delay |
| LP-WUS | traffic mode is predictable | requirement |
| PDCCH | Trigger monitoring of the | Trigger by using the first |
| monitoring | first LP-WUS before drx- | LP-WUS out of the |
| | onDurationTimer | conventional C-DRX |
| | | active time |

A power, consumed for LP-WUS monitoring, of the terminal device is much less than that for PDCCH monitoring. A smaller monitoring cycle of the LP-WUS may indicate a smaller service delay. In some implementations, the monitoring cycle of the first LP-WUS is less than the cycle of the first timer. For example, if the cycle of the first timer is a C-DRX cycle, the monitoring cycle of the first LP-WUS is less than a long C-DRX cycle and/or a short C-DRX cycle.

In some implementations, the first LP-WUS carries one or more of the following: an identity of the terminal device; information used to instruct the terminal device to trigger monitoring of the PDCCH; or information used to instruct the terminal device to monitor a carrier of the PDCCH.

In some implementations, the identity of the terminal device may be a radio network temporary identity (radio network temporary identity, RNTI). For example, a 16-bit RNTI is used to uniquely identify a specific terminal device in a connected state, and the first LP-WUS carries the RNTI, so that the terminal device determines whether the first LP-WUS is used to wake up the terminal device, to avoid false wake-up.

In some implementations, that the first LP-WUS carries the information used to instruct the terminal device to trigger monitoring of the PDCCH may be understood as that the terminal device receives the first LP-WUS, and may trigger monitoring of the PDCCH in the first time period based on the information that is used to instruct the terminal device to trigger monitoring of the PDCCH and that is carried in the first LP-WUS.

In some implementations, that the first LP-WUS carries the information used to instruct the terminal device to monitor the carrier of the PDCCH may be understood as that the terminal device receives the first LP-WUS, and may determine, based on the first LP-WUS, the carrier on which the terminal device monitors the PDCCH. The terminal device supports the LP-WUS in a case that carrier aggregation (carrier aggregation, CA) is configured in the connected state. For CA, the LP-WUS is supported in waking up only a part of carriers, to save power of the terminal device.

The LP-WUS may be supported in waking up only a part of carriers to save a power through carrier aggregation (CA) in the connected state. By flexibly managing active states of a plurality of carriers, the LP-WUS can be used to help the terminal device wake up only a part of carriers, thereby reducing unnecessary power consumption. In a carrier aggregation scenario, the terminal device may use a plurality of carriers (for example, a primary carrier and a secondary carrier) at the same time. Generally, RF components of the plurality of carriers remain in an active state. However, in many cases, data transmission does not need to be performed on all the carriers.

In some implementations, the information used to instruct the terminal device to monitor the carrier of the PDCCH may be a bitmap. One or more carriers are indicated by using the bitmap. This method allows flexible data scheduling and energy saving opportunities. Some terminal devices may disable RF components of specific carriers. Therefore, there is no need to enable or disable all carriers. When wake-up is required, the bitmap indicates specific carriers that are required to participate in data transmission, instead of activating all carriers at the same time. The bitmap (bitmap) is a mechanism used to indicate a carrier wake-up state. By using the bitmap, the network device can flexibly control which carriers is to be woken up, and which carriers can remain in an off state or a low-power state.

In some implementations, each bit (bit) of the bitmap corresponds to a specific carrier. If the bit is “1”, it indicates that the carrier needs to woken up and prepare to receive data. If the bit is “0”, it indicates that the carrier may remain in a sleep state or an off state. This mechanism reduces unnecessary power consumption and quickly wakes up a carrier for data transmission as required. For example, in a specific scenario, the network device may use only a small quantity of carriers to transmit data, to avoid unnecessary carrier switching and signal interference. Such scheduling flexibility facilitates optimization of utilization of network resources and improvement of overall energy efficiency performance.

Based on the information used to instruct the terminal device to monitor the carrier of the PDCCH in the LP-WUS, one or more serving cells applicable to the LP-WUS may be determined, or the LP-WUS is applicable to all activated serving cells. Generally, a power saving mode is more suitable for single CA. However, the mechanism should also work in a CA mode. The mechanism may not be optimal. RF of the first receiver and RF of the second receiver are very independent of each other on different carriers. Therefore, it is difficult to support cross-carrier association of the LP-WUS. In some implementations, one serving cell should be indicated by only a first LP-WUS on a same carrier.

To avoid any dislocation of the network device and the terminal device in activating PDCCH monitoring by using an LP-WUS, the terminal device may transmit an acknowledgment message to the network device. In some implementations, the terminal device transmits first acknowledgment information to the network device. The first acknowledgment information is used to instruct the terminal device to receive the first LP-WUS.

In some implementations, before the terminal device monitors the first LP-WUS, the terminal device receives a trigger message transmitted by the network device, where the trigger message is used to trigger the first receiver of the terminal device to wake up the second receiver of the terminal device, and power consumption of the first receiver is higher than power consumption of the second receiver.

In some implementations, that the trigger message is used to trigger the first receiver of the terminal device to wake up the second receiver of the terminal device may be understood as that the trigger message is used to trigger the first receiver of the terminal device to wake up the second receiver of the terminal device and trigger the second receiver of the terminal device to monitor the first LP-WUS. For example, with reference to FIG. 8, the first receiver is an MR, and the second receiver is an LR. Before the trigger message is received, the MR is in an on state, and the LR is in an off state. After the MR receives the trigger message, the MR is triggered to wake up the LR, and the LR enters an on state and starts to monitor the first LP-WUS.

In some implementations, the terminal device transmits second acknowledgment information to the network device. The second acknowledgment information is used to instruct the terminal device to receive the trigger message.

In some implementations, the first acknowledgment information and the second acknowledgment information may be carried in the same request. For example, after the second receiver of the terminal device receives the first LP-WUS, the first receiver of the terminal device transmits a request that carries the first acknowledgment information and the second acknowledgment information, to acknowledge that the terminal device receives the trigger message and the first LP-WUS.

In some other implementations, the first acknowledgment information and the second acknowledgment information may be carried in different requests. For example, with reference to FIG. 8, the first receiver is an MR, and the second receiver is an LR. The network device transmits a trigger request to the MR of the terminal device. After receiving the trigger message, the MR of the terminal device triggers the LR to switch from an off state to an on state. The MR of the terminal device transmits a second acknowledgment request to the network device. The second acknowledgment request carries the second acknowledgment information, to confirm that the MR successfully receives the trigger message. The LR of the terminal device monitors the first LP-WUS in the on state. When the LR of the terminal device receives the first LP-WUS, the MR of the terminal device transmits a first acknowledgment request to the network device. The first acknowledgment request carries the first acknowledgment information, to confirm that the LR successfully receives the first LP-WUS. After a handshake process, the network device and the terminal device reach a reliable consensus on use of the MR or the LR, to avoid a loss of transmission or reception between the network device and the terminal device.

In some implementations, if the network device misses the first acknowledgment information and the second acknowledgment information, the network device may retransmit the trigger message or the first LP-WUS until an acknowledgment message is received.

In some implementations, after the terminal device transmits the first acknowledgment information, the first receiver of the terminal device enters the sleep state. For example, with reference to FIG. 8, the first receiver is an MR, the second receiver is an LR, and after the MR transmits the first acknowledgment information to the network device, the MR enters a sleep state from an on state after a delay.

It may be learned from the foregoing that the terminal device may include the first receiver and the second receiver. An important problem relates to a hypothesis about whether the first receiver and the second receiver can simultaneously receive a DL signal. In some implementations, this capability is closely related to implementation of the terminal device.

For example, if there is switching between an antenna and the first receiver or the second receiver, the terminal device can definitely use only one of the two receivers at a time point. If the first receiver and the second receiver are connected to the antenna without a switch, the terminal device may use the two receivers at the same time. Because a total receive power is divided into different branches (corresponding to different receivers), there may be some signal power losses. If the power is equally distributed to two branches (that is, two receivers), the two receivers may introduce a signal to noise ratio loss of several dB. The terminal device has only one receiver. In this case, in the connected mode, the LP-WUS may at least trigger PDCCH monitoring when DL traffic arrives.

In some implementations, if the terminal device includes two receivers, that is, the foregoing first receiver and the foregoing second receiver, the terminal device may also enable the first receiver to receive a DL signal from the network device based on a capability of the terminal device and an implementation mechanism.

In the connected state, the LP-WUS is used to instruct to trigger PDCCH monitoring of the first receiver, and the LP-WUS affects only PDCCH monitoring of the first receiver. For a DL configured resource, for example, DL semi-persistent scheduling (semi-persistent scheduling, SPS), because the network device allocates a DL SPS resource when knowing that the LP-WUS is enabled, the network device expects the terminal device to perform a conventional operation on a DL SPS resource, and the terminal device and the network device do not mismatch on monitoring of the first receiver or the second receiver. In some implementations, the terminal device should monitor the DL SPS resource by using the first receiver to avoid any DL data loss.

However, for a UL configured resource, such as a configured grant type 1 or a configured grant type 2 (UL SPS), there are sometimes UL configured assets, but the terminal device does not have UL data for transmission. If UL skipping is not enabled, the terminal device should still transmit padding bits in the UL configured resource. This may cause additional power consumption. In some implementations, if the terminal device is using the first LP-WUS to trigger PDCCH monitoring, and no UL data is available, a UL configuration is skipped. In this way, the terminal device does not need to enable the first receiver and continue to monitor the LP-WUS, to facilitate further reduction of power consumption of the terminal device.

Because power consumption of monitoring the first LP-WUS at the second receiver is far lower than power consumption of monitoring the PDCCH at the first receiver, PDCCH monitoring may be additionally triggered based on the conventional C-DRX cycle. If the first timer is to be started based on a service mode or another factor, and the timer is not started by the first LP-WUS, the terminal device is required to determine whether the second LP-WUS is to be monitored during running of the first timer.

In some implementations, if starting of the first timer is not triggered by the first LP-WUS, the terminal device performs one or more of the following operations during running of the first timer: monitoring no second LP-WUS, where the second LP-WUS is transmitted by the network device to the terminal device after the first LP-WUS; monitoring the second LP-WUS; or determining, based on the first LP-WUS, whether to monitor the second LP-WUS.

In some implementations, that starting of the first timer is not triggered by the first LP-WUS may be understood as follows: The terminal device has not monitored or received the first LP-WUS, and the first timer is started based on a conventional C-DRX configuration.

In some implementations, that starting of the first timer is not triggered by the first LP-WUS may be understood as follows: The terminal device receives the first LP-WUS, where the first LP-WUS does not instruct to trigger starting of the first timer; and the first timer is started based on a conventional C-DRX configuration.

In some implementations, the determining, based on the first LP-WUS, whether to monitor the second LP-WUS may be understood as follows: The terminal device receives the first LP-WUS, where the first LP-WUS does not instruct to trigger starting of the first timer, and the first timer is started based on the conventional C-DRX cycle; and during running of the first timer, the terminal device determines, based on information indicated by the first LP-WUS, whether to monitor the second LP-WUS.

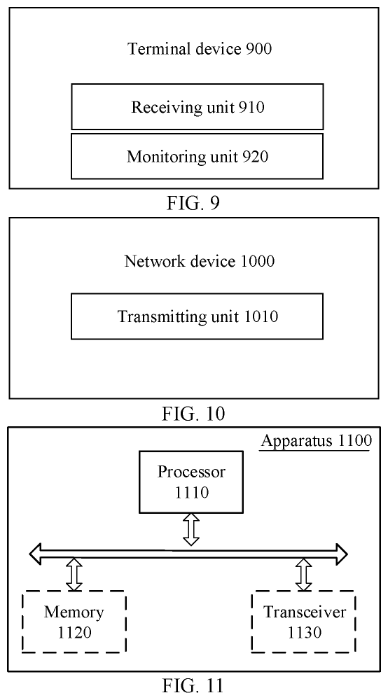

The method embodiments of the present application are described in detail above with reference to FIG. 1 to FIG. 8. Apparatus embodiments of the present application are described in detail below with reference to FIG. 9 to FIG. 11. It should be understood that the description of the method embodiments corresponds to the description of the apparatus embodiments, and therefore, for a part that is not described in detail, reference may be made to the foregoing method embodiments.

FIG. 9 is a schematic diagram of a terminal device according to an embodiment of the present application. The terminal device 900 shown in FIG. 9 includes a receiving unit 910 and a monitoring unit 920.

The receiving unit 910 is configured to receive a first low-power wake-up signal LP-WUS transmitted by a network device.

The monitoring unit 920 is configured to: in response to reception of the first LP-WUS, monitor a physical downlink control channel PDCCH in a first time period.

In some implementations, the first time period is determined based on a first timer, and the first timer includes one or more of the following: a discontinuous reception DRX inactivity timer; a DRX on duration timer; or a timer triggered by the first LP-WUS.

In some implementations, the first timer is determined based on one or more of the following: a service type; a data transmission mode; a data traffic feature; a quality of service requirement; or network load information.

In some implementations, a start time of the first timer is determined based on a first time window and a first time offset, and the first time window is used to monitor the first LP-WUS.

In some implementations, the first time offset is used to indicate a time interval between a start time of the first time window and a start time of the first timer; or the first time offset is used to indicate a time interval between an end time of the first time window and a start time of the first timer.

In some implementations, the first time offset is configured by the network device, and the first time offset is determined based on one or more of the following: one or more candidate values of the first time offset reported by the terminal device; one or more candidate values of the first time offset supported by a subcarrier spacing SCS; location information of the terminal device; a resource scheduling congestion degree; a data transmission cycle; a wake-up delay of the terminal device; a processing delay of the terminal device; or a monitoring cycle of the first LP-WUS.

In some implementations, the candidate value is determined based on one or more of the following: a time of processing the first LP-WUS by the terminal device; a transition time of switching from a second receiver of the terminal device to a first receiver of the terminal device, where power consumption of the first receiver is higher than power consumption of the second receiver; a synchronization duration of the first receiver; an SCS; a sleep type supported by the terminal device; a data transmission delay requirement; or network status information.

In some implementations, a duration of the first timer is determined based on a data transmission duration.

In some implementations, a cycle of the first timer is determined based on a data transmission cycle.

In some implementations, the first time window includes monitoring occasions of a plurality of first LP-WUSs, and the monitoring occasion is determined based on one or more of the following: a system frame number; a subframe number; a monitoring cycle of the first LP-WUS; or a monitoring start offset of the first LP-WUS.

In some implementations, a start time of the first time window is determined based on one or more of the following: a data transmission start time; or a monitoring cycle of the first LP-WUS.

In some implementations, a parameter of the first time window and/or the first timer is determined based on a network load and/or traffic information by using a model.

In some implementations, the first LP-WUS carries one or more of the following: an identity of the terminal device; information used to instruct the terminal device to trigger monitoring of the PDCCH; or information used to instruct the terminal device to monitor a carrier of the PDCCH.

In some implementations, the terminal device further includes: a transmitting unit, transmitting first acknowledgment information to the network device, where the first acknowledgment information is used to indicate that the terminal device receives the first LP-WUS.

In some implementations, the terminal device further includes: before the monitoring unit monitors the first LP-WUS, the receiving unit 910 is further configured to receive a trigger message transmitted by the network device, where the trigger message is used to trigger a first receiver of the terminal device to wake up a second receiver of the terminal device, and power consumption of the first receiver is higher than power consumption of the second receiver.

In some implementations, the terminal device further includes: the transmitting unit is further configured to transmit second acknowledgment information to the network device, where the second acknowledgment information is used to indicate that the terminal device receives the trigger message.

In some implementations, the terminal device further includes: an execution unit, where if starting of the first timer is not triggered by the first LP-WUS, the execution unit is configured to perform one or more of the following operations in a running period of the first timer: monitoring no second LP-WUS, where the second LP-WUS is transmitted by the network device to the terminal device after the first LP-WUS; monitoring the second LP-WUS; or determining, based on the first LP-WUS, whether to monitor the second LP-WUS.

FIG. 10 is a schematic diagram of a network device according to an embodiment of the present application. The network device 1000 shown in FIG. 10 includes a transmitting unit 1010.

The transmitting unit 1010 is configured to transmit a first low-power wake-up signal LP-WUS to a terminal device, where the first LP-WUS is used to trigger the terminal device to monitor a physical downlink control channel PDCCH in a first time period.

In some implementations, the first time period is determined based on a first timer, and the first timer includes one or more of the following: a discontinuous reception DRX inactivity timer; a DRX on duration timer; or a timer triggered by the first LP-WUS.

In some implementations, the first timer is determined based on one or more of the following: a service type; a data transmission mode; a data traffic feature; a quality of service requirement; or network load information.

In some implementations, a start time of the first timer is determined based on a first time window and a first time offset, and the first time window is used to monitor the first LP-WUS.

In some implementations, the first time offset is used to indicate a time interval between a start time of the first time window and a start time of the first timer; or the first time offset is used to indicate a time interval between an end time of the first time window and a start time of the first timer.

In some implementations, the first time offset is configured by the network device, and the first time offset is determined based on one or more of the following: one or more candidate values of the first time offset reported by the terminal device; one or more candidate values of the first time offset supported by a subcarrier spacing SCS; location information of the terminal device; a resource scheduling congestion degree; a data transmission cycle; a wake-up delay of the terminal device; a processing delay of the terminal device; or a monitoring cycle of the first LP-WUS.

In some implementations, the candidate value is determined based on one or more of the following: a time of processing the first LP-WUS by the terminal device; a transition time of switching from a second receiver of the terminal device to a first receiver of the terminal device, where power consumption of the first receiver is higher than power consumption of the second receiver; a synchronization duration of the first receiver; a subcarrier spacing SCS; a sleep type supported by the terminal device; a data transmission delay requirement; or network status information.

In some implementations, a duration of the first timer is determined based on a data transmission duration.

In some implementations, a cycle of the first timer is determined based on a data transmission cycle.

In some implementations, the first time window includes monitoring occasions of a plurality of first LP-WUSs, and the monitoring occasion is determined based on one or more of the following: a system frame number; a subframe number; a monitoring cycle of the first LP-WUS; or a monitoring start offset of the first LP-WUS.

In some implementations, a start time of the first time window is determined based on one or more of the following: a data transmission start time; or a monitoring cycle of the first LP-WUS.

In some implementations, a parameter of the first time window and/or the first timer is determined based on a network load and/or traffic information by using a model.

In some implementations, the first LP-WUS carries one or more of the following: an identity of the terminal device; information used to instruct the terminal device to trigger monitoring of the PDCCH; or information used to instruct the terminal device to monitor a carrier of the PDCCH.

In some implementations, the network device further includes: a receiving unit, receiving first acknowledgment information transmitted by the terminal device, where the first acknowledgment information is used to indicate that the terminal device receives the first LP-WUS.

In some implementations, the network device further includes: before the transmitting unit 1010 transmits the first LP-WUS, the transmitting unit 1010 is further configured to transmit a trigger message to the terminal device, where the trigger message is used to trigger a first receiver of the terminal device to wake up a second receiver of the terminal device, and power consumption of the first receiver is higher than power consumption of the second receiver.

In some implementations, the network device further includes: the receiving unit is further configured to receive second acknowledgment information transmitted by the terminal device, where the second acknowledgment information is used to indicate that the terminal device receives the trigger message.

In an optional embodiment, the receiving unit 910 may be a transceiver 1130, and the monitoring unit 920 may alternatively be a processor 1110. The terminal device 900 may further include a processor 1110 and a memory 1120, which are specifically shown in FIG. 11.

In an optional embodiment, the transmitting unit 1010 may be a transceiver 1130. The network device 1000 may further include a processor 1110 and a memory 1120, which are specifically shown in FIG. 11.

FIG. 11 is a schematic structural diagram of a communications apparatus according to an embodiment of the present application. Dashed lines in FIG. 11 indicate that a unit or module is optional. The apparatus 1100 may be configured to implement the methods described in the foregoing method embodiments. The apparatus 1100 may be a chip, a terminal device, or a network device.

The apparatus 1100 may include one or more processors 1110. The processor 1110 may support the apparatus 1100 in implementing the methods described in the foregoing method embodiments. The processor 1110 may be a general-purpose processor or a dedicated processor. For example, the processor may be a central processing unit (central processing unit, CPU). Alternatively, the processor may be another general-purpose processor, a digital signal processor (digital signal processor, DSP), an application specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1100 may further include one or more memories 1120. The memory 1120 stores a program, and the program may be executed by the processor 1110, so that the processor 1110 executes the method described in the foregoing method embodiment. The memory 1120 may be separate from the processor 1110 or may be integrated into the processor 1110.

The apparatus 1100 may further include a transceiver 1130. The processor 1110 may communicate with another device or chip by using the transceiver 1130. For example, the processor 1110 may transmit data to and receive data from another device or chip by using the transceiver 1130.

An embodiment of the present application further provides a computer-readable storage medium for storing a program. The computer-readable storage medium may be applied to the terminal device or the network device provided in embodiments of the present application, and the program causes a computer to execute the methods performed by the terminal device or the network device in various embodiments of the present application.

An embodiment of the present application further provides a computer program product. The computer program product includes a program. The computer program product may be applied to the terminal device or the network device provided in embodiments of the present application, and the program causes a computer to perform the methods performed by the terminal device or the network device in various embodiments of the present application.

An embodiment of the present application further provides a computer program.

The computer program may be applied to a terminal device or a network device provided in embodiments of the present application, and the computer program causes a computer to perform the methods performed by the terminal device or the network device in various embodiments of the present application.

It should be understood that the terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular sequence. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, the “protocol” may refer to a standard protocol in the communications field, and may include, for example, an LTE protocol, an NR protocol, and a related protocol applied to a future communications system, which is not limited in the present application.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution sequences. The execution sequences of the processes should be determined according to functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

The units described as separate parts may be or may not be physically separate, and parts displayed as units may be or may not be physical units, and may be at one location, or may be distributed on a plurality of network elements. A part or all of the units may be selected based on actual requirements to achieve the objectives of the solutions of embodiments.

In addition, functional units in embodiments of the present application may be integrated into one processing unit, or each of the units may exist alone physically, or two or more units may be integrated into one unit.

All or a part of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
receiving, by a terminal device, a first low-power wake-up signal (LP-WUS) from a network device; and
in response to receiving the first LP-WUS, monitoring, by the terminal device, a physical downlink control channel (PDCCH) in a first time period.

2. The method according to claim 1, wherein the first time period corresponds to a duration of a first timer, and the first timer comprises one or more of following:
a discontinuous reception DRX inactivity timer;
a DRX on duration timer; or
a timer triggered by the first LP-WUS.

3. The method according to claim 2, wherein the first timer corresponds to one or more of following:
a service type;
a data transmission mode;
a data traffic feature;
a quality of service requirement; or
network load information.

4. The method according to claim 2, wherein a start time of the first timer corresponds to a first time window and a first time offset, and the first time window is used to monitor the first LP-WUS.

5. The method according to claim 4, wherein the first time offset indicates a time interval between a start time of the first time window and a start time of the first timer; or
the first time offset indicates a time interval between an end time of the first time window and a start time of the first timer.

6. The method according to claim 5, wherein the first time offset is configured by the network device, and the first time offset corresponds to one or more of following:
one or more candidate values of the first time offset reported by the terminal device;
one or more candidate values of the first time offset supported by a subcarrier spacing (SCS);
location information of the terminal device;
a resource scheduling congestion degree;
a data transmission cycle;
a wake-up delay of the terminal device;
a processing delay of the terminal device; or
a monitoring cycle of the first LP-WUS.

7. The method according to claim 6, wherein the candidate value is determined based on one or more of following:
a time of processing the first LP-WUS by the terminal device;
a transition time of switching from a second receiver of the terminal device to a first receiver of the terminal device, wherein power consumption of the first receiver is higher than power consumption of the second receiver;
a synchronization duration of the first receiver;
an SCS;
a sleep type supported by the terminal device;
a data transmission delay requirement; or
network status information.

8. The method according to claim 2, wherein a duration of the first timer corresponds to a data transmission duration.

9. The method according to claim 2, wherein a cycle of the first timer corresponds to a data transmission cycle.

10. The method according to claim 4, wherein the first time window comprises monitoring occasions of a plurality of first LP-WUSs, and the monitoring occasion corresponds to one or more of following:
a system frame number;
a subframe number;
a monitoring cycle of the first LP-WUS; or
a monitoring start offset of the first LP-WUS.

11. The method according to claim 4, wherein a start time of the first time window corresponds to one or more of following:
a data transmission start time; or
a monitoring cycle of the first LP-WUS.

12. The method according to claim 4, wherein a parameter of at least one of the first time window or the first timer corresponds to at least one of a network load or traffic information based on a model.

13. The method according to claim 1, wherein the first LP-WUS carries one or more of following:
an identity of the terminal device;
information used to instruct the terminal device to trigger monitoring of the PDCCH; or
information used to instruct the terminal device to monitor a carrier of the PDCCH.

14. The method according to claim 1, wherein the method further comprises:
transmitting, by the terminal device, first acknowledgment information to the network device, wherein the first acknowledgment information indicates that the terminal device receives the first LP-WUS.

15. The method according to claim 1, wherein the method further comprises:
before the terminal device monitors the first LP-WUS, receiving, by the terminal device, a trigger message from the network device, wherein the trigger message is used to trigger a first receiver of the terminal device to wake up a second receiver of the terminal device, and power consumption of the first receiver is higher than power consumption of the second receiver.

16. The method according to claim 15, wherein the method further comprises:
transmitting, by the terminal device, second acknowledgment information to the network device, wherein the second acknowledgment information indicates that the terminal device receives the trigger message.

17. The method according to claim 2, wherein the method further comprises:
when starting of the first timer is not triggered by the first LP-WUS, performing, by the terminal device, one or more of following operations in a running period of the first timer:
refraining from monitoring a second LP-WUS, wherein the second LP-WUS is transmitted by the network device to the terminal device after the first LP-WUS;
monitoring the second LP-WUS; or
determining, based on the first LP-WUS, whether to monitor the second LP-WUS.

18. A wireless communication method, comprising:
transmitting, by a network device, a first low-power wake-up signal (LP-WUS) to a terminal device, wherein
the first LP-WUS is used to trigger the terminal device to monitor a physical downlink control channel (PDCCH) in a first time period.

19. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving a first low-power wake-up signal (LP-WUS) from a network device; and
in response to receiving the first LP-WUS, monitoring a physical downlink control channel (PDCCH) in a first time period.

20. The apparatus according to claim 19, wherein the first time period corresponds to a duration of a first timer, and the first timer comprises one or more of following:
a discontinuous reception DRX inactivity timer;
a DRX on duration timer; or
a timer triggered by the first LP-WUS.
